(19) United States
(12) Patent Application Publication
(10) Pub. No.: US 2011/0050115 A1
(43) Pub. Date: Mar. 3, 2011

(54) METHOD AND IGNITER FOR IGNITING A GAS DISCHARGE LAMP

(75) Inventors: Johan L.V. Hendrix, Turnhout (BE); Guido De Beuckelaer, Turnhout (BE); Stijn A.M. Geudens, Turnhout (BE); Rene Van Honschooten, Eindhoven (NL); Jean-luc C.O. Massage, Turnhout (BE); Guy Proth, Turnhout (BE)

(73) Assignee: KONINKLIJKE PHILIPS ELECTRONICS N.V., EINDHOVEN (NL)

(21) Appl. No.: 12/744,071

(22) PCT Filed: Nov. 24, 2008
(86) PCT No.: PCT/IB2008/054915

§ 371 Date: Nov. 12, 2010

(30) Foreign Application Priority Data
Nov. 29, 2007 (EP) 07121906.7

(51) Int. Cl. H05B 41/24

(52) U.S. Cl. 315/279; 315/246; 315/276

(57) ABSTRACT

A method of igniting a gas discharge lamp (2) comprises the steps of first applying a plurality of high-voltage ignition pulses with a relatively low amplitude and subsequently applying high-voltage ignition pulses with a relatively high amplitude. Switching over from generating low-amplitude ignition pulses to generating high-amplitude ignition pulses may be done on the basis of counting the low-amplitude ignition pulses or on the basis of monitoring the duration of the period during which the low-amplitude ignition pulses are generated.

### FIELD OF THE INVENTION

The present invention relates in general to the field of driving a gas discharge lamp, specifically the field of igniting a high-intensity discharge lamp (HID). Particularly, the present invention relates to an igniter for a metal halide lamp (MH).

### BACKGROUND OF THE INVENTION

Gas discharge lamps in general, and more particularly HID lamps, are commonly known, so a detailed explanation is not needed here. It suffices to say that such a lamp comprises a sealed gas chamber with two electrodes at a certain distance from each other.

When the lamp is “on”, a discharge current is established between the two electrodes, and a lamp voltage develops across the electrodes. A driver must be capable of providing power having the same voltage as the lamp and a steady state lamp current value. When the lamp is “off”, and it is required that the lamp is switched on, it would seem obvious to provide power having the lamp voltage, but unfortunately a gas discharge lamp requires a higher voltage for ignition. Thus, it is customary to provide an ignitor circuit capable of generating high-voltage pulses; when the lamp ignites, the steady state power supply takes over.

Now, a problem is that the required height (i.e. voltage magnitude) of such ignition pulses depends on the condition of the lamp. If the lamp is hot (i.e. has extinguished only recently), higher ignition pulses are required as compared to the situation that the lamp is cold. It would be possible to design a lamp driver for the worst case scenario, so that it would always apply the higher voltage ignition pulses suitable for igniting hot lamps, but this is not desirable because these higher voltage pulses are disadvantageous to the lamp and may reduce the lifetime of the lamp (for instance, lamp parts may fail due to the high voltages applied) or may reduce lamp performance during life (for instance, luminous flux may be reduced).

### SUMMARY OF THE INVENTION

An object of the present invention is to overcome these problems and disadvantages. Particularly, the present invention aims to provide an ignition circuit for a high-intensity gas discharge lamp, capable of igniting cold lamps as well as hot lamps without unnecessarily reducing the lifetime of such lamps.

According to an important aspect of the present invention, initially, ignition pulses are generated with a relatively low amplitude, suitable for igniting a cold lamp, and the lamp response is monitored. If the lamp does not ignite, ignition pulses are generated with a relatively high amplitude, suitable for igniting a hot lamp. Thus, it is ensured that the lamp is ignited with the relatively high amplitude pulses only when this is needed.

It is noted that U.S. Pat. No. 5,084,655 discloses an ignition circuit designed to first apply a small ignition pulse, and to apply a large ignition pulse only if the small ignition pulse does not succeed in igniting the lamp. However, the circuit of this disclosure always generates one small ignition pulse during one half of the lamp current period followed by one large ignition pulse during the subsequent half of the lamp current period (the current frequency being 50 Hz). However, the present inventors have found that in practice there exists a problem in that a lamp usually does not ignite on the basis of one ignition pulse only, even if such a pulse has a sufficient magnitude per se. Thus, a cold lamp not being ignited with the first small ignition pulse would always receive a second large pulse. There is a chance that the lamp does not even ignite immediately on such a large pulse. So, the lamp would receive a train of alternating large and small pulses, and the plurality of large pulses in this train are disadvantageous for the lifetime of lamp parts. In addition, once the lamp ignites, the chance is considerably higher than 50% that ignition was caused by a large pulse; thus, the lifetime of the lamp will still be reduced due to ignition on large pulses.

An object of the present invention is to overcome these problems as well. To this end, the present invention proposes that first a train of smaller ignition pulses is generated, the train for instance having a duration in the range of half a second to several seconds. Only if the lamp has not ignited after this train of smaller ignition pulses, larger ignition pulses are generated until the lamp ignites.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 schematically shows a block diagram of an electronic driver for a gas discharge lamp;

FIG. 2 is a block diagram schematically illustrating an embodiment of an igniter.

### DETAILED DESCRIPTION OF THE INVENTION

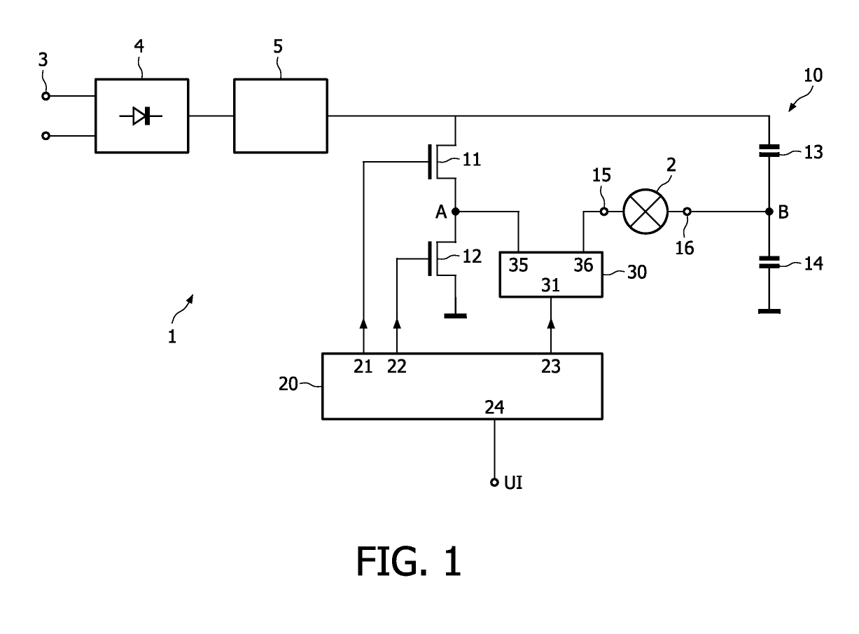

FIG. 1 schematically shows a block diagram of an exemplary embodiment of an electronic driver 1 for a gas discharge lamp 2. The driver 1 comprises input terminals 3 for connection to mains (for instance 230 V @ 50 Hz), a rectifying section 4 for rectifying the mains voltage, and a converter section 5 for converting the rectified voltage received from the rectifying section 4 into a substantially constant current. Further, the driver 1 comprises a commutator section 10 for commutating the output current provided by the converter section 5. In the embodiment as depicted, the commutator section 10 has a well-known H-shaped bridge configuration comprising a series arrangement of two switches 11, 12 in parallel with a series arrangement of two capacitors 13, 14. Lamp output terminals 15, 16 for connecting the lamp 2 are coupled (via an igniter, as will be explained below) to a node A between the two switches 11, 12 and a node B between the two capacitors 13, 14, respectively. A controller 20 has output terminals 21, 22 coupled to control input terminals of the two switches 11, 12, respectively. Such a general driver design is know per se, and a more detailed explanation of this design and its operation is not needed here. It is noted that various other possibilities exist for implementing a lamp current supply.

The driver 1 further comprises an igniter circuit 30, which may be controlled by a separate control circuit but which in the embodiment depicted is controlled by the said controller 20. To this end, an igniter control output 23 of the controller 20 is coupled to a control input 31 of the igniter circuit 30. The igniter 30, arranged between node A and the lamp, is coupled in series with said lamp 2.

At its output terminals 21, 22, the controller 20 generates control signals for the two switches 11, 12, respectively, such as to alternatively open and close these switches. Depending on which switch is open and which switch is closed, lamp current either flows from node A to node B, or vice versa, assuming that the lamp is ON. The controller 20 may implement low-frequency square wave current, as should be clear to a person skilled in the art, although other modes of current generation are also feasible.

The driver 1 comprises a user input UI, coupled to a user input terminal 24 of the controller 20, via which a user may input a command to switch on the lamp. On receipt of such an input command, the controller 20 starts the switching of the switches 11, 12 and also starts the igniter 30. It is also possible that the controller starts operating on power-up.

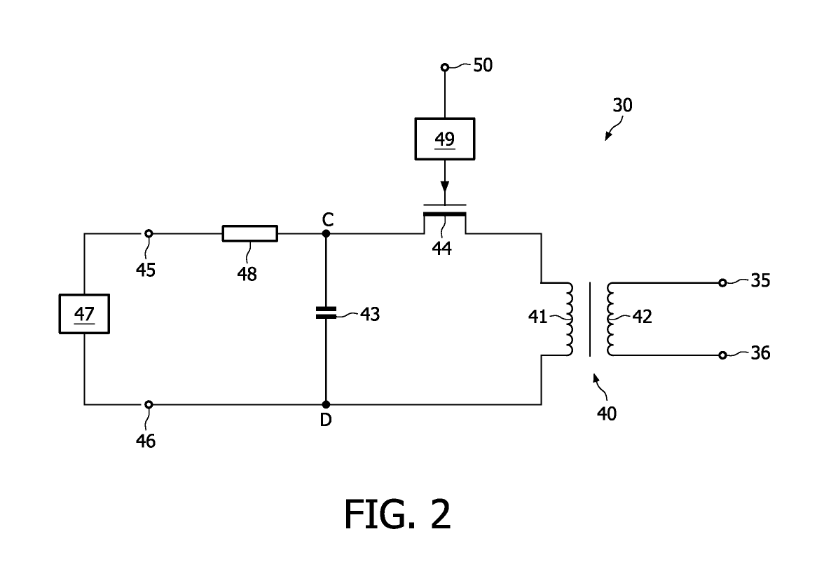

FIG. 2 is a block diagram schematically illustrating some more details of an embodiment of the igniter 30. Although other designs are possible, the igniter 30 in this embodiment comprises a transformer 40 having a primary winding 41 and a secondary winding 42. The secondary winding 42 has its output terminals coupled to the output terminals 35, 36 of the igniter 30. The igniter 30 further comprises a capacitor 43 arranged in parallel with the primary transformer winding 41, and a controllable switch 44 (typically a MOSFET or an IGBT or the like) connected between the capacitor 43 and the primary transformer winding 41. The igniter 30 has input terminals 45, 46 for receiving power from an igniter supply 47, typically a source of DC voltage. A resistor 48 has one terminal coupled to a first input terminal 45 and has its other terminal coupled to the node C between the capacitor 43 and the switch 44. The second input terminal 46 is coupled to the node D between the capacitor 43 and the primary transformer winding 41.

The ignition circuit is capable of operating in at least two different states. In a first state the switch 44 is closed (i.e. conductive), and in a second state the switch 44 is open (i.e. non-conductive). The igniter 30 further comprises an igniter controller 49 for controlling the state of the switch 44. This may involve a separate controller, but this function may also be performed by the main controller 20. Or, both controllers may be integrated.

The operation of the igniter 30 is as follows. Let us assume that the switch 44 is open. The capacitor 43 is charged via the resistor 48, and the voltage at node C rises with respect to the voltage at node D. When the igniter controller 49 closes the switch 44, the capacitor 43 is discharged over the primary transformer winding 41, causing a high voltage pulse at the transformer output terminals 35, 36. Then, the igniter controller 49 opens the switch 44, the capacitor 43 is charged again, and the above is repeated at a certain repetition frequency.

The igniter controller 49 is capable of operating in at least two modes. In a first mode, indicated as “cold start mode”, the voltage at node C is relatively low at the moment when the igniter controller 49 closes the switch 44, so that the resulting high voltage pulse at the transformer output terminals 35, 36 has a relatively low pulse magnitude and a relatively low energy content. In a second mode, indicated as “hot start mode”, the voltage at node C is relatively high at the moment when the igniter controller 49 closes the switch 44, so that the resulting high-voltage pulse at the transformer output terminals 35, 36 has a relatively high pulse magnitude and a relatively high energy content.

In an example, the igniter supply 47 may provide a supply voltage of 400 V, the capacitor 43 may be charged to about 80 V in the cold start mode, and the capacitor 43 may be charged to about 350 V in the hot start mode.

The igniter controller 49 may be provided with a timer (not shown), in which case the igniter controller 49 may decide to close the switch 44 on the basis of the time that has passed since the moment when the switch 44 was opened: the longer this time, the higher the voltage at node C. It is also possible that the igniter controller 49 is provided with a reference voltage source and a comparator, and a sensor for sensing the capacitor voltage at node C, in which case the igniter controller 49 may decide to close the switch 44 on the basis of the actual capacitor voltage at node C.

In response to receiving a lamp start command, the igniter controller 49 is designed to initially operate in its first mode, i.e. the cold start mode, during a certain time period which will be indicated as the “cold start period” having a certain “cold start duration”. During the cold start period, typically, a plurality of high-voltage pulses with relatively low pulse magnitude will be generated, i.e. the cold start duration is much longer than the pulse repetition period. The duration of the cold start period may be determined on the basis of time since start: the igniter controller 49 may be provided with a timer (not shown), and the igniter controller 49 may be designed to compare the time-since-start with a predetermined time value stored in a memory, as should be clear to a person skilled in the art. The duration of the cold start period may also be determined on the basis of the number of pulses: the igniter may comprise a counter, and may be designed to compare the number of pulses (i.e. the number of times that the switch 44 was closed) with a predetermined count value stored in a memory, as should be clear to a person skilled in the art.

A typical suitable value for the cold start duration is in the order of 0.5 second to 10 seconds. The number of pulses is typically in the order of 100 per second.

The igniter controller 49 has an input 50 for receiving a signal indicating that the lamp has ignited. Such a signal may for instance be provided by a lamp current sensor, or by an optical sensor detecting the lamp light. As soon as the signal received at input 50 indicates the occurrence of a discharge in the lamp, the igniter controller 49 generates a constant control output signal for the switch 44 such as to keep the switch opened, so that no further ignition pulses are generated. If the igniter controller 49 finds that the cold start period has ended while the lamp has not yet started to discharge, the igniter controller 49 switches over to the hot start mode such as to generate pulses with more energy.

Summarizing, the present invention provides a method of igniting a gas discharge lamp. The method comprises the steps of first applying a plurality of high-voltage ignition pulses with a relatively low amplitude and subsequently applying high-voltage ignition pulses with a relatively high amplitude. Switching over from generating low-amplitude ignition pulses to generating high-amplitude ignition pulses may be done on the basis of counting the low-amplitude ignition pulses or on the basis of monitoring the duration of the period during which the low-amplitude ignition pulses are generated.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, instead of selecting one of two possible voltage levels, the igniter may also be designed to select from three or more voltage levels, increasing the voltage level stepwise or gradually.

Further, the igniter may be designed to operate on the basis of a different operating principle. In the above example, the igniter is based on the principle of pulse generation. The height of the generated pulses can easily be varied by varying the charging time of the capacitor 43. It is also possible that the height of the generated pulses is varied by varying the voltage of the igniter supply 47. Alternatively, it would also be possible to use an igniter operating on the basis of resonance: the operating frequency in a resonance circuit is slowly shifted towards resonance, and is prevented from reaching the resonance peak in the cold start mode. In yet another alternative, it is possible to use a combination of a resonance circuit and a pulse circuit: the resonance circuit would be designed to generate the cold start ignition voltage, while the pulse circuit would be added to superimpose hot start ignition pulses if, after some time, the cold start ignition voltage has not succeeded in igniting the lamp. In all of these and other implementations, the igniter would first generate a series of “cold start attempts”, and if unsuccessful would then generate a series of “hot restrike attempts”.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional blocks is performed by individual hardware components, but it is also possible that one or more of these functional blocks are implemented in software, so that the function of such a functional block is performed by one or more program lines of a computer program or a programmable device such as a microprocessor, microcontroller, digital signal processor, etc.

1. Method of igniting a gas discharge lamp (2), the method comprising the steps of first applying a high-voltage ignition pulse with a relatively low amplitude and subsequently applying a high-voltage ignition pulse with a relatively high amplitude, wherein initially a plurality of high-voltage ignition pulses with a relatively low amplitude are applied, after which high-voltage ignition pulses with a relatively high amplitude are applied.

2. Igniter (30) for a gas discharge lamp (2), having output terminals (35, 36) for providing high-voltage ignition pulses to a lamp in order to cause ignition of such a lamp, the igniter being capable of operating in a cold start mode and in a hot start mode, wherein the amplitude of the ignition pulses generated during the hot start mode is higher than the amplitude of the ignition pulses generated during the cold start mode, and wherein the igniter is designed to initially operate in the cold start mode such as to generate a plurality of ignition pulses and then switch over to operating in the hot start mode.

3. Igniter according to claim 2, wherein the igniter is designed to initially operate in the cold start mode for a cold start period having a predetermined cold start duration, and switch over to operating in the hot start mode if at the end of the cold start period the lamp has not yet ignited.

4. Igniter according to claim 2, wherein the igniter is designed to count the number of ignition pulses generated during the cold start mode, and switch over to operating in the hot start mode if upon reaching a predetermined number the lamp has not yet ignited.

5. Igniter according to claim 2, wherein the igniter comprises:
a pulse transformer (40) having a secondary winding (42) coupled to an igniter output (35, 36);
a capacitor (43) coupled to a primary winding (41) of the pulse transformer;
a controllable switch (44) arranged between the capacitor (43) and the primary transformer winding (41);
a supply (47) for charging the capacitor (43) when the switch (44) is open;
an igniter controller (49) for controlling the switch (44),
wherein the igniter controller (49) is designed to generate a high-voltage ignition pulse to close the switch.

6. Igniter according to claim 5, wherein the igniter controller (49) is designed to open the switch in order to start charging the capacitor (43), to monitor the voltage across the capacitor (43), to compare the capacitor voltage with a predetermined reference voltage, and to close the switch when the capacitor voltage reaches the reference voltage.

7. Igniter according to claim 6, wherein during the cold start mode the igniter controller (49) compares the capacitor voltage with a first predetermined reference voltage, and wherein during the hot start mode the igniter controller (49) compares the capacitor voltage with a second predetermined reference voltage higher than the first predetermined reference voltage.

8. Igniter according to claim 5, wherein the igniter controller (49) is designed to open the switch in order to start charging the capacitor (43), to monitor time, and to close the switch when a predetermined time period has passed since opening of the switch.

9. Igniter according to claim 8, wherein during the cold start mode the igniter controller (49) closes the switch when a first predetermined time period has passed, and wherein during the hot start mode the igniter controller (49) closes the switch when a second predetermined time period longer than the first predetermined time period has passed.
